(19) United States
(12) Patent Application Publication
(10) Pub. No.: US 2014/0025393 A1
(43) Pub. Date: Jan. 23, 2014

(54) SYSTEM AND METHOD FOR PROVIDING CLINICAL DECISION SUPPORT

(71) Applicants: Kang Wang, Lexington, MA (US); Wilson S. Wong, Archadia, CA (US); Dmitry Berdichevsky, Newton, MA (US)

(72) Inventors: Kang Wang, Lexington, MA (US); Wilson S. Wong, Archadia, CA (US); Dmitry Berdichevsky, Newton, MA (US)

(21) Appl. No.: 13/942,925

(22) Filed: Jul. 16, 2013

Related U.S. Application Data
(60) Provisional application No. 61/672,541, filed on Jul. 17, 2012.

(51) Int. Cl. G06F 19/00

(52) U.S. Cl. CPC G06F 19/3443
USPC 705/2

(57) ABSTRACT

A clinical decision support system comprises a memory device having a plurality of routines stored therein, a processor configured to execute the plurality of routines stored in the memory device, the plurality of routines comprising a routine configured to receive primary clinical information from a user associated with a patient, a routine configured to derive expanded clinical information from the user-provided primary clinical information, a routine configured to identify relevant rules from a data store based on the user-provided clinical information and the expanded clinical information, a routine configured to compute a diagnostic relevancy score for each of the identified relevant rules; a routine configured to assign by the processing device the computed diagnostic relevancy score to each identified relevant rule, and a routine configured to display each identified rule in ranked order based on the rule's assigned diagnostic relevancy score.

### CROSS REFERENCE TO RELATED APPLICATIONS

The present invention claims priority to U.S. Provisional Patent Application Ser. No. 61/672,541, which is incorporated herein by reference in its entirety, titled “Clinical Decision Support System, Method, Device, and Computer Product”, was filed on Jul. 17, 2012.

### FIELD OF THE INVENTION

The present invention generally relates to the medical arts, medical diagnostic arts and related arts. More particularly, the present invention relates to systems, methods, devices and computer program products for the management of data to support patient diagnosis.

### BACKGROUND

Medical imaging represents a substantial and growing portion of the costs of American health care. When performed correctly and for the right reasons, medical imaging facilitates quality medical care that brings value to both patients and payers. When used incorrectly because of inappropriate economic incentives, unnecessary patient demands, or provider concerns for medical-legal risk, imaging costs can rise without increasing diagnostic yields. The United States spent 100 billion a year for radiology services. Multiple studies have shown that up to 50% of high technology imaging fails to provide any useful information and may be unnecessary. Further, 26% of imaging studies ordered at primary care clinics were considered inappropriate or unnecessary. Economics aside, patient safety is also at issue. The overuse of CT scans alone results in 12 preventable radiation-induced cancer deaths a day. A number of methods have been tried to manage imaging utilization and achieve the best medical outcomes for patients without incurring unnecessary costs. In response to the double-digit rise in high-tech imaging utilization, the health care industry recognized a need to manage this growth by implementing imaging utilization control programs to reduce health care costs. These imaging utilization control programs are typically implemented by special purpose Radiology Benefits Management companies (RBMs). Authorization is a process utilized by many health plans to determine the appropriateness of medical imaging studies prior to actual study performance by the imaging provider. The primary intent of prior-authorization is to provide health plans a means by which to control imaging utilization. Payment for studies subject to prior-authorization is contingent upon health plan approval and Prior-authorization number assignment. Approval of studies subject to prior-authorization is based in part, upon patient clinical history which is generally maintained by the ordering physician office.

Over recent years, the number of imaging studies requiring prior-authorization has increased significantly. Consequently, the ordering physician office has become more disenchanted by the administrative burden and added staffing costs to complete prior authorization activities. As a result, many physician offices have become increasingly insistent that the responsibility for prior-authorization be redirected to imaging providers. Some imaging providers view obtaining prior-authorizations as a means to improve the process, protect revenue and differentiate it from other imaging providers. Factors influencing the imaging providers' decision to accept or deny such requests are comprised of a myriad of issues including: customer service and operational considerations, regulatory compliance, managed care organization (MCO), contract restrictions and risk of payment denials if the physician office fails to correctly manage the prior authorization process. Another challenge for some imaging providers considering performance of prior-authorization is managing the inconsistencies with health plan and RBM contract/policies.

Finally, requirements for prior-authorization are dynamic and imaging providers rely heavily upon their front office staff to maintain a working knowledge of updates to health plan policies, processes and systems related to prior authorization. The financial penalty for failure of the physicians' office to properly secure the prior authorization is born solely by the imaging provider. And, it is unrealistic to expect that physicians' offices will stay abreast of the ever changing prior-authorization requirements and the nuances of each health plan's processes and software since they have no vested interest in doing so.

For these and other reasons, many imaging providers struggle with the cost-benefit of prior-authorization performance. A better solution would be to reduce errors at the point of order entry in light of evidence based guidelines in the patient context. In addition to reducing errors, duplication detection at the point of order entry and proactive detection of inappropriate orders provide better solutions to the status quo.

What are needed are systems, methods and computer program products for providing clinical decision support to physicians and other health care professionals in a proactive and interactive manner.

### SUMMARY

In accordance with one disclosed aspect, a clinical decision support (CDS) method comprises: receiving from a user, at a processing device, primary clinical information associated with a patient, wherein the primary clinical information includes one or more primary clinical terms; deriving, by the processing device, expanded clinical information from the user-provided primary clinical information, wherein the expanded clinical information includes one or more expanded clinical terms; identifying, by the processing device, one or more relevant rules based on the user-provided primary clinical information and the expanded clinical information, computing, by the processing device, the diagnostic relevancy score for each identified rule, and displaying each identified relevant rule to the user in ranked order based on the rule's diagnostic relevancy score.

In accordance with another disclosed aspect, a storage medium is disclosed, the storage medium storing instructions executable by a digital signal processor to perform the clinical decision support (CDS) method set forth in the immediately preceding paragraph.

In accordance with another disclosed aspect, a clinical decision support system comprises: a memory device having a plurality of routines stored therein; a processor configured to execute the plurality of routines stored in the memory device, the plurality of routines comprising: a routine configured to, when executed, receive primary clinical information from a user associated with a patient; a routine configured to, when executed, derive expanded clinical information from the user-provided primary clinical information; a routine configured to, when executed, identify relevant rules from a data store based on the user-provided clinical information and the expanded clinical information; a routine configured to, when executed, compute a diagnostic relevancy score for each of the identified relevant rules; a routine configured to, when executed, assign, by the processing device, the computed diagnostic relevancy score to each identified relevant rule; and a routine configured to, when executed, display each identified rule in ranked order based on the rule's assigned diagnostic relevancy score.

### BRIEF DESCRIPTION OF THE DRAWINGS

These and other objects, features and advantages of the invention will be apparent from a consideration of the following Detailed Description Of The Invention considered in conjunction with the drawing figures in which:

FIG. 1—diagrammatically shows a clinical decision support system in an exemplary computing environment, according to one embodiment.

FIG. 2—illustrates an exemplary Extract, Transfer and Load (ETL) component of the clinical decision support system, according to one embodiment.

FIG. 3—illustrates exemplary hardware and software used by the clinical decision support system of the invention, according to one embodiment.

FIG. 4—is a flow diagram of an exemplary method that may be used to provide clinical decision support in accordance with an embodiment of the present invention.

FIG. 5—is a more detailed flow diagram of step 406 of the flow diagram of FIG. 4, according to one embodiment.

FIG. 6—illustrates an exemplary portion of a rule set organized as a hierarchical decision tree.

FIG. 7—is a more detailed flow diagram of step 408 of the flow diagram of FIG. 4 in accordance with one embodiment.

FIG. 8—is a flow diagram of steps performed during a pre-operational stage according to one embodiment.

FIGS. 9-15—show display screenshots illustrating various aspects of the clinical decision support system of FIG. 1.

### DETAILED DESCRIPTION OF THE INVENTION

Non-limiting embodiments of the present invention will now be disclosed in detail, by way of example, with reference to the drawings. In describing those embodiments, specific terminology will be resorted to for the sake of clarity. However, the invention is not intended to be limited to the specific terms so selected, and it is to be understood that each specific term includes all technical equivalents that operate in similar manner to accomplish a similar purpose.

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a HD), hardware circuitry or the like, or any combination.

Reference now will be made in detail to the presently preferred embodiments of the invention. Such embodiments are provided by way of explanation of the invention, which is not intended to be limited thereto. In fact, those of ordinary skill in the art may appreciate upon reading the present specification and viewing the present drawings that various modifications and variations can be made.

For example, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the scope of the present invention.

For purposes of the present invention “health care condition” and “patient condition” is broadly defined to mean a condition in the nature of a disease or an organic dysfunction or a “condition” that might also be viewed as a status or an outcome.

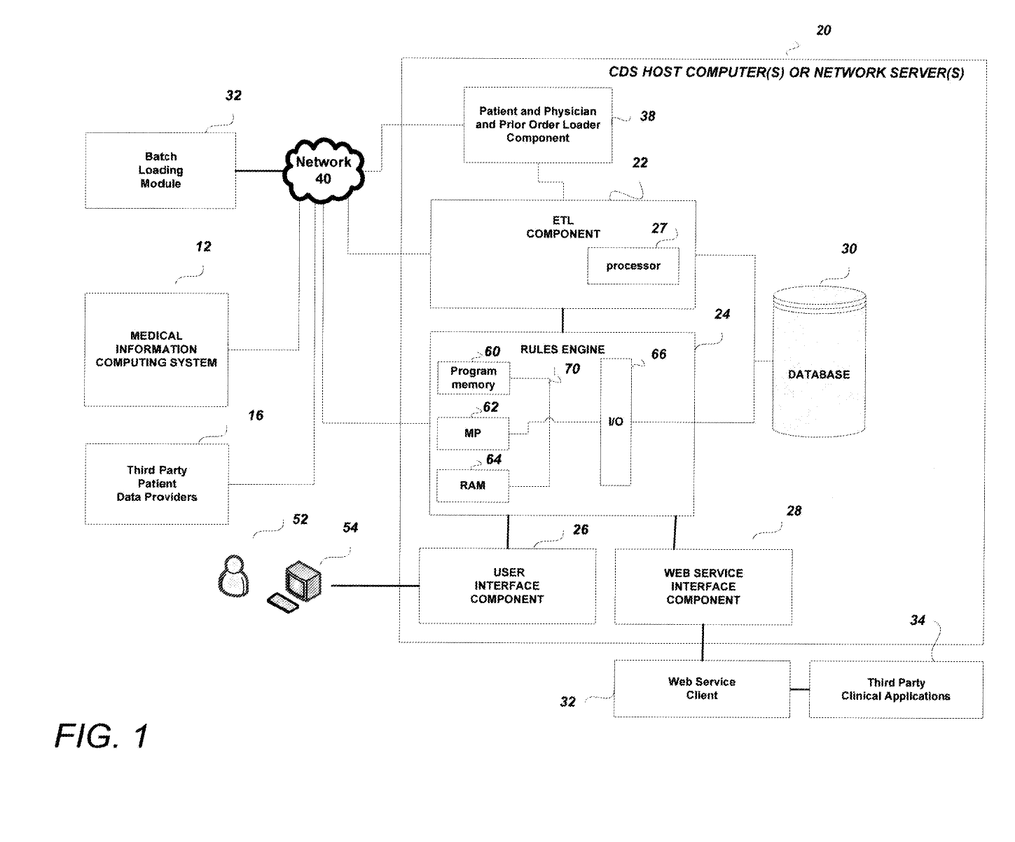

With reference to FIG. 1, a clinical decision support (CDS) system is maintained on a suitable digital processing system 20, such as a CDS system host computer or computers, or a CDS system host network server or network servers, or so forth. The digital processing system 20 may in general be a single computer or network server, or may comprise a plurality of interconnecting computers and/or network servers. Other digital processing devices or device combinations are also contemplated.

The CDS system provides clinical decision support to healthcare professionals. In an embodiment, the CDS system adds decision support to EHR systems. Toward this end, a medically knowledgeable user 52 operates a computer 54 or other user interface to interact with the CDS system in order to receive patient procedure recommendations from the CDS system based on a number of patient conditions supplied by the user 52.

In one embodiment, components of the clinical decision support system includes an extract, transfer and load (ETL) component 22, a rules engine 24 component, a user interface component 26, a web service interface component 28, a patient and physician and prior order loader component 34, and a data repository 30 for storing: (a) a single system compatible rule set, (b) various medical dictionaries such as ICD9, CPT, SNOMED code sets, (c) patient information, (d) past orders, and (e) mappings between conditions/candidate procedures.

In an embodiment, the rules engine 24 may include a program memory 60, a microcontroller or a microprocessor (MP) 62, a random-access memory (RAM) 64, and an input/output (I/O) circuit 66, all of which may be interconnected via an address/data bus 70. It should be appreciated that although only one microprocessor 62 is shown, the rules engine 24 may include multiple microprocessors 62. Similarly, the memory of the rules engine 24 may include multiple RAMs 64 and multiple program memories 60. Although the I/O circuit 66 is shown as a single block, it should be appreciated that the I/O circuit 66 may include a number of different types of I/O circuits. The RAM(s) 64 and programs memories 60 may be implemented as semiconductor memories, magnetically readable memories, and/or optically readable memories, for example. The rules engine 24 may also be operatively connected to the network 40 via a link 72.

In an embodiment, the data repository 30 can be made secure with password protection. Once the data repository 30 is populated, the contents are used by the clinical decision support system to provide clinical decision support information.

The couplings between the various components of the clinical decision support system may be wired or wireless, and may be provided by one or more networks, such as a LAN, a WAN, an intranet, the Internet or a combination thereof. Where the network comprises the Internet, data communication may take place over the network via an Internet communication protocol.

The ETL component 22 includes at least one processor 27 configured to receive rules from various rule providers and convert the imported rule sets into a single system compatible rule set to be stored in the data repository 30 for access by the rules engine 24. It should be noted that, while not shown, additional databases and/or data repositories may be linked to the rules engine 24 in a known manner.

The rules engine component 24 includes at least one processor (MP) 62 and is configured to receive inputs from a user including primary clinical information associated with a patient, derive expanded clinical information from the user-provided primary clinical information. The rules engine component 24 is also configured to identify one or more relevant rules from a database storing a plurality of rules, based on the user-provided primary clinical information and the expanded clinical information, compute the diagnostic relevancy score for each identified rule, and display each identified relevant rule to the user in ranked order based on the rule's diagnostic relevancy score.

The user interface component 26 is configured to display the various outputs of the rules engine component 24 and to enable health care professionals to select a recommended procedure and/or provide further inputs.

The web service interface component 28 is configured to communicate with third party clinical applications 34 via a web service clients interface component 32. It is used by third party applications such as an electronic health records (EHR) system to add decision support functions to their existing functions. The web service interface component 28 receives one or more initial clinical parameters for individual patients from an external system, such as an EHR system, and returns one or more ranked rules as identified by rules engine component 24 based on the user provided clinical information.

FIG. 1 also describes at a very high level, the relationship between the CDS system 20 and third party patient data providers 16, such as insurance companies.

The CDS System may reside on a server and/or storage accessible thereby for execution by the server, where the server is accessible by a plurality of computers. For example, a user, such as a physician, may operate a workstation, such as a personal computer, in order to use the CDS system, where execution of the CDS system is performed at the server or at the workstation. Alternatively, the CDS system may reside on one or more workstations and/or storage devices accessible thereby for execution by the work station.

A human user(s) interact with the CDS system to request clinical decision support information for current patient cases. The user of the CDS system is typically a physician or other medical person or plurality of medical persons. However, the user of the CDS system is not necessarily a senior physician, specialist, or other highly skilled medical diagnostician. Rather, the user of the CDS user system may be an ordinary physician of ordinary skill who utilizes the CDS system to obtain assistance in making clinical decisions. In general, the user of the CDS system may be a physician or other medical personnel of substantially any skill level.

Although the clinical decision support system is shown in FIG. 1 interfaced with the medical information computing system 12, one skilled in the art will recognize that in embodiments, the CDS system may be integrated into the medical information computing system 12. In other embodiments, it is recognized that the clinical decision support system may simply be interfaced with a data repository storing a single system rule set and other clinical information independent of a comprehensive medical information computing system 12. However, by interfacing and/or integrating the clinical decision support system with a comprehensive medical information computing system 12, a number of advantages may be realized. For example, the medical information computing system 12 may be interfaced with or otherwise include computing devices and/or computing systems in a variety of different clinical domains within a healthcare environment. By way of example only and not limitation, the medical information computing system 12 may include a clinical laboratory system, a pharmacy system, a radiology system, and a hospital administration system. Accordingly, the medical information computing system 12, provides a unified computing architecture that is able to access and aggregate clinical information from a variety of different clinical domains and make the clinical information available to the CDS system.

Another advantage of interfacing and/or integrating the CDS system with the medical information computing system 12 is that clinical decision support may be provided at the point-of-care via a remote computer. For instance, the medical information computing system 12 may include a number of remote computers. The remote computers may be located at, for example, patients' bedsides, nurses' stations, and physicians' offices. Accordingly, physicians may be able to access the clinical decision support engine 20 via a remote computer of the medical information computing system 12, such that clinical decision support may be provided at the point-of-care.

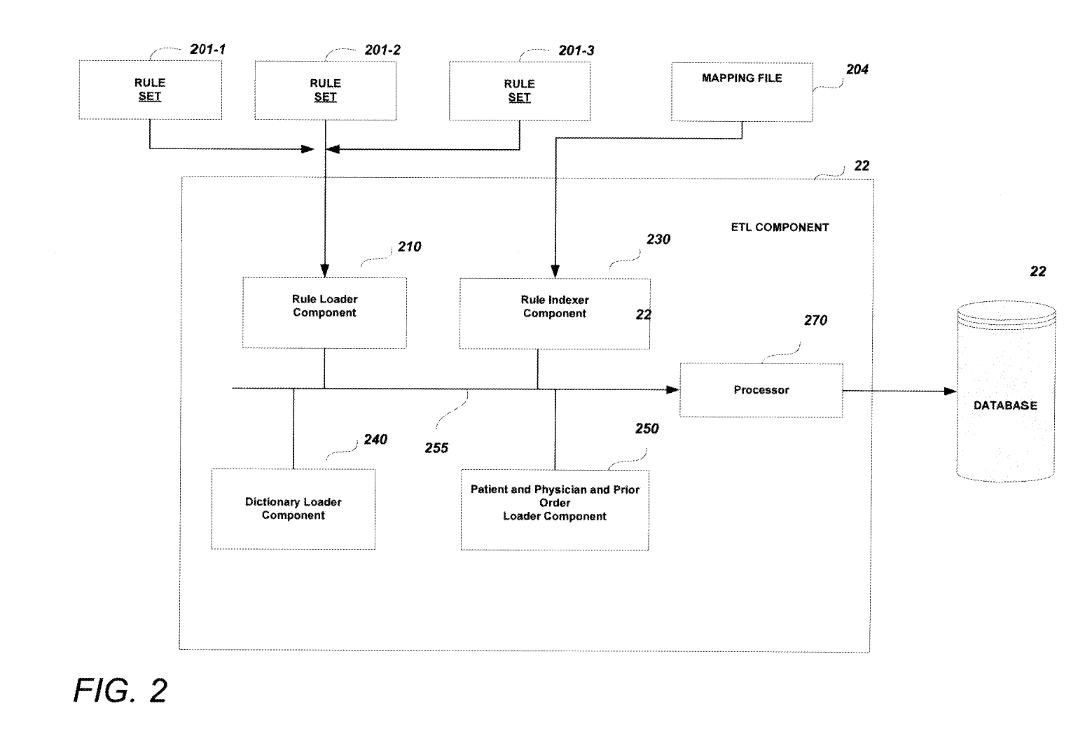

Referring now to FIG. 2, a block diagram is provided illustrating an exemplary ETL component 22 according to one embodiment. The ETL component 22 is configured to load standard medical dictionaries such as ICD9 code set and CPT code set using the ETL Dictionary Loader component 240. The ETL component 22 converts the imported rule sets into a single system compatible rule set.

As shown in FIG. 2, in one embodiment, the ETL component 220 may include a rules loader component 210, a rules indexer component 230, a dictionary loader component 240 and a patient and physician prior order loader component 250, where each component is coupled to a processor 270 via a communication bus 255.

The rules loader component 210 is configured to receive one or more external rule sets 201-1, 201-2, 201-3, three of which are shown by way of example only. The rule sets may include, for example, American College of Radiology (ACR) rule sets, American College of Cardiology (ACC) rule sets, NCCN rule sets, and institution specific rule set, provided from one or more rule providers. The CDS system is not bound by a specific number of rule sets and may include any number of rule sets as required by a particular application.

The ETL Dictionary loader component 240 is configured to receive dictionary data such as SNOMED, IC9 and CPT codes from one or more third-party sources.

The Rules Indexer component 230 is configured to receive a mapping file 204. The mapping file 204 is organized as a set of associations between user-provided clinical terms and patient conditions as an aid in identifying, by the rules engine component 24, relevant rules from a single compatible rule set stored in the data repository 30.

Table I illustrates an exemplary mapping file record entry in accordance with one embodiment. Typically, a mapping file will include thousands of entries associating particular patient conditions with one or more clinical terms. A single record is shown below for ease of explanation. The mapping file associations are typically industry expert created associations.

As shown, the mapping file record entry associates a patient condition with one or more clinical terms. In the exemplary record nine clinical terms are mapped to the patient condition, Gastrointestinal condition, i.e., “Left Lower Quadrant Pain—Suspected Diverticulitis”. The associations between patient conditions and clinical terms are commonly referred to as pairings which are industry expert created associations between patient conditions and clinical terms. In an embodiment, each pairing of a clinical term and a patient condition in the mapping file is assigned a weight value. In the example, weight values of 100 and 200 have been assigned to the nine pairings. In the example, the scale is 0-200, however, other ranges are within contemplation of the invention.

In an embodiment, the pairing's weight value is used to partially calculate a rule's diagnostic relevancy score, as will be described further below.

Referring again to FIG. 2, the Rule Indexer component 230, is configured to import the mapping file from an external source to be loaded by the CDS system during a pre-configuration stage. The mapping file is used by the Rules Engine 24 to generated diagnostic relevancy scores.

TABLE I

| Patient Condition | Clinical Terms |
|---|---|
| Gastrointestinal | |
| Left Lower Quadrant Pain - | Diverticular disease of colon (disorder), |
| Suspected Diverticulitis | (weight = 200) |
| | Diverticulitis of colon (disorder), |
| | (weight = 200) |
| | Rectal hemorrhage (disorder), (weight = |
| | 100) |
| | Acute abdominal pain (finding), |
| | (weight = 100) |
| | LLQ pain, (weight = 100) |
| | Diverticulitis of sigmoid colon |
| | (disorder), (weight = 200) |
| | Left lower quadrant pain (finding), |
| | (weight = 100) |
| | Diverticulitis (disorder), (weight = 200) |
| | Abdominal pain (finding), (weight = |
| | 100) |

Interfacing with External Systems

At start-up, the CDS System loads the single system compatible rule set prepared by the CDS system ETL component 22. The single system compatible rule set can be invoked in multiple ways. The most generic way of calling for services from the CDS system is via Web Service Interface component 28. In its most generic form, a call for CDS services requires as input a list of clinical facts about a patient, and returns a list of ranked rules that are applicable to the list of clinical facts and facts derived therefrom.

A typical, but not exclusive, remote third party system is an external Electronic Health Record (EHR) system that interacts with the CDS system to provide decision support functions for its users. In this case, the EHR system will pass patient demographic information, current conditions and/or to be assessed problems of the patient, past history of the patient as facts to the CDS system as input and in return receive, as an initial response, a list of ranked rules. The external EHR system can then display the ranked rules to enable a user to select the appropriate procedures. The external EHR system can also provide, as input to the CDS system, user selected procedures in addition to the above mentioned inputs, and receive from the CDS system, a list of ranked rules, as discussed above, and an appropriateness score for each user selected procedure input from the EHR system.

The CDS system can also receive individualized patient data from a user 52 who may enter commands and information from the user's remote computer 54 into the CDS system via UI interface component 26.

The CDS system can also receive commands and information, sent in batch form to the CDS system via the patient/physician/prior order loader component 38. This entry method is typically used to support a batch load mechanism to bulk and/or batch load large numbers of documents to support loading of patient prior history. The batch loading is preferably performed via a network 40, such as the Internet.

The information received in batch and non-batch form are translated to a system compatible format by the Patient and Physician and Prior Order Loader Component 38 and stored in the data repository 30.

### Data Standardization

To further facilitate the seamless exchange of data, the present invention utilizes an interface vocabulary or ontology within the CDS system. The interface vocabulary is mapped to a variety of standardized reference vocabularies, such as the Systematized Nomenclature of Medicine, Clinical Terms (SNOMED CT) to manage data. SNOMED CT is a scientifically validated collection of well-formed, machine-readable, and multi-lingual healthcare terminology that provides a standardized nomenclature for use in capturing, indexing, sharing, and aggregating healthcare data across specialties and sites of care. Because the common language employed by SNOMED CT reduces the variability in the way data is captured, encoded, and used, it is particularly suited for use in electronic medical records, clinical decision support, medical research studies, clinical trials, computerized physician order entry, disease surveillance, image indexing, and consumer health information services. SNOMED CT is currently maintained by the International Health Terminology Standards Development Organization (IHTSDO). The contents of the SNOMED CT medical vocabulary are hereby incorporated by reference in their entirety.

Data in the form of customer generated rules and clinical terms linked to those rules are loaded by the ETL dictionary loader component 240 into the data repository 30. The data, when necessary, is translated into a controlled medical vocabulary (e.g., SNOMED CT) by the Rule Indexer component 230. The data is parsed out into its component parts, those parts are matched to certain recognized clinical terminology, and specific portions of that data are then associated with the corresponding clinical coding.

In addition to pre-coordinated expressions that provide a single concept ID for a predefined concept definition, SNOMED CT also includes broader concept definitions that allow new expressions to be post-coordinated using multiple concept IDs. Thus, if recognized medical terminology cannot be matched to a specific concept definition with a single, pre-coordinated expression, the recognized medical terminology can still be captured in a meaningful way in the SNOMED CT format.

### Exemplary Hardware and Software

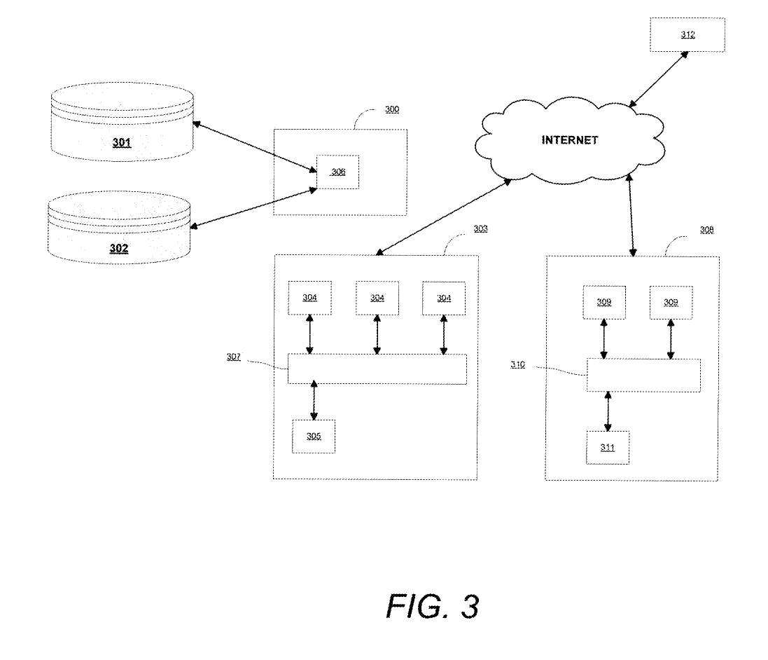

Exemplary hardware and software employed by the systems discussed herein are now generally described with reference to FIG. 3. Database server(s) 300 may include a database services management application 306 that manages storage and retrieval of data from the database(s) 301, 302. The databases may be relational databases; however, other data organizational structure may be used without departing from the scope of the present invention. One or more application server(s) 303 are in communication with the database server 300. The application server 303 communicates requests for data to the database server 300. The database server 300 retrieves the requested data. The application server 303 may also send data to the database server for storage in the database(s) 301, 302. The application server 303 comprises one or more processors 304, computer readable storage media 305 that store programs (computer readable instructions) for execution by the processor(s), and an interface 307 between the processor(s) 304 and computer readable storage media 305. The application server may store the computer programs referred to herein.

To the extent data and information is communicated over the Internet, one or more Internet servers 308 may be employed. The Internet server 308 also comprises one or more processors 309, computer readable storage media 311 that store programs (computer readable instructions) for execution by the processor(s) 309, and an interface 310 between the processor(s) 309 and computer readable storage media 311. The Internet server 308 is employed to deliver content that can be accessed through the communications network. When data is requested through an application, such as an Internet browser, the Internet server 308 receives and processes the request. The Internet server 308 sends the data or application requested along with user interface instructions for displaying a user interface.

The computers referenced herein are specially programmed, in accordance with the described algorithms, to perform the functionality described herein.

The non-transitory computer readable storage media that store the programs (i.e., software components comprising computer readable instructions) may include volatile and non-volatile, removable and non-removable media implemented in any method or technology for storage of information such as computer-readable instructions, data structures, program components, or other data. Computer readable storage media may include, but is not limited to, RAM, ROM, Erasable Programmable ROM (EPROM), Electrically Erasable Programmable ROM (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computer system and processed.

The computer applications described herein may be hosted in a public, private or hybrid Internet cloud environment, in some embodiments.

In addition, the CDS system is capable of recognizing incongruities between the patient demographic and the facts provided to the system by a health care provider. For example, if the patient information includes abdominal pain which is linked with a rule concerning pregnant women with abdominal pain, then this rule will normally be presented to the user for this patient. But if the patient gender is male, the CDS system recognizes that the rule is invalid for male patients and discards the rule.

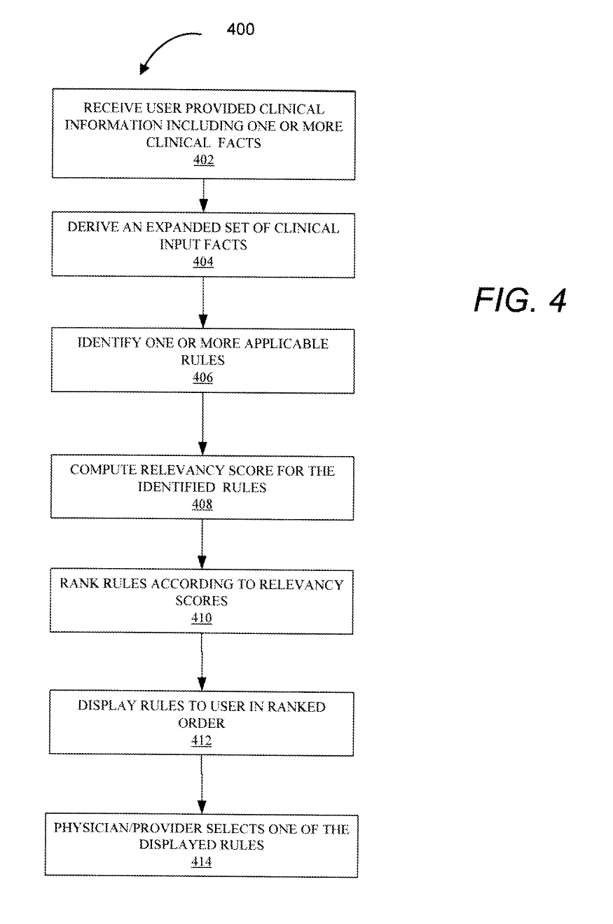

FIG. 4 is a flow diagram of an exemplary method 400 that may be used to provide clinical decision support in accordance with an embodiment of the present invention. The method 400 includes the following steps.

At step 402, receiving at a processing device, primary clinical information including one or more clinical terms or facts from a user (e.g., physician, nurse, etc.).

At step 404, deriving, by the processing device, expanded clinical information including one or more expanded clinical terms from the user-provided primary clinical information. The system expands the user provided primary clinical information to generate expanded clinical information either by inference or by querying internal or external data sources. For example, patient age can be derived from the date of birth and the current date, patient past exams can be retrieved from the rules based data store, patient allergy information can be retrieved from external Electronic Medical Record System.

At step 406, identify relevant rules by the rules engine component 24 based on the user-provided clinical information and expanded clinical information

At step 408, compute the diagnostic relevancy score for the identified rules by the rules engine component 24.

At step 410, the rules are ranked according to the computed diagnostic relevancy scores.

At step 412, the rules are displayed to the user in ranked order.

At step 414, the user may select one of the displayed rules and is shown the set of candidate procedures for the selected rule.

It should be appreciated that the process does not terminate with the selection of a displayed candidate procedure. The user may optionally perform additional actions that further refine the rule identification process. For example, a user has the option of negating a displayed rule, providing a user specified procedure in addition to those identified by the CDS system, provide additional input clinical information to refine the search for relevant rules subsequent to being shown a set of displayed rules.

### Rule Identification

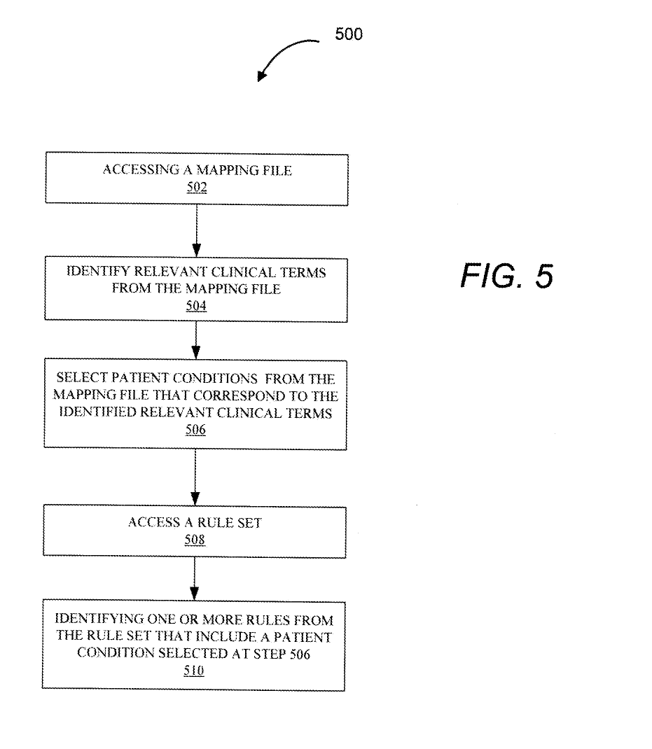

FIG. 5 is a more detailed flow diagram of step 406 of the flow diagram of FIG. 4 in accordance with one embodiment. Step 406 is directed to the identification of relevant rules by the rules engine component 24 based on the user-provided clinical information and expanded clinical information

At step 502, access, by a processing device, a mapping file comprising mapping data, wherein the mapping data comprises a plurality of data records, where each record associates patient conditions to clinical terms.

At step 504, identify, by a processing device, any clinical terms from the mapping file that match any of the user-provided primary clinical terms or expanded clinical terms.

At step 506, select the patient conditions from the mapping file that correspond to the clinical terms identified at step 504.

At step 508, access a rule set, by the processing device, the rule comprising a set of rules, wherein each rule in the rule set comprises data associating one or more patient conditions to one or more candidate procedures.

At step 510, identify one or more rules from the rule set that include at least one of the patient conditions selected at step 506.

It is recognized that in some instances an identified rule should be negated based on one or more of the clinical terms provided by a physician. For example, if a patient is male and the physician enters abdominal pain as a clinical input fact and if one of the identified rules is about pregnant women with abdominal pain, that rule would be excluded by the CDS system.

Typically, in response to a user interacting with the CDS system and inputting one or more clinical terms for a patient, the rules engine 24 of the CDS system will use the user-provided clinical terms as one input and derive further clinical terms as a second input to identify and return multiple rules that are determined to be relevant from the rule set stored in the data repository 30. This process is described above at a high level at step 406 of the flow diagram of FIG. 4 and at a more detailed level with respect to the flow diagram of FIG. 5. Once the relevant rules have been identified, the rules are ranked by computing a diagnostic relevancy score for each rule using a rule ranking algorithm. In one embodiment, the rule ranking algorithm is invoked by the rules engine 24 to rank the one or more identified rules according to certain predefined criteria including: (1) the user provided clinical information including one or more clinical terms, (2) further clinical terms that are derived from the user provided clinical information by the rules engine 24, (3) past user selections of the rule in question under the given clinical terms and (4) expert assigned weights based on the expert generated mapping from patient conditions to clinical terms. Other embodiments may use different combinations of the above criteria and/or other criteria.

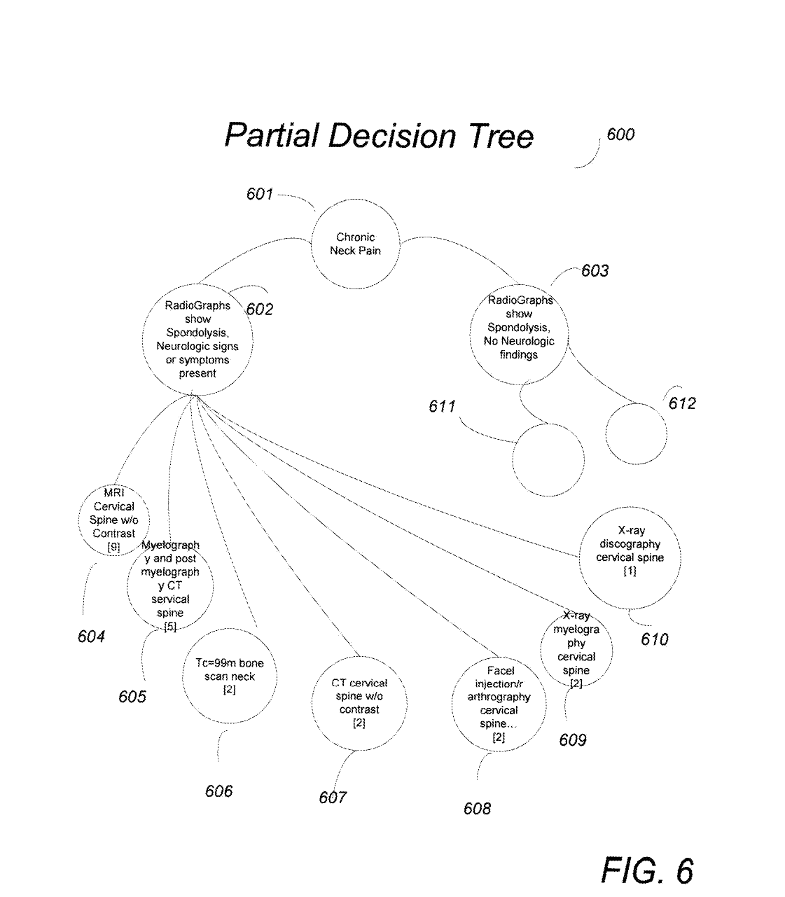

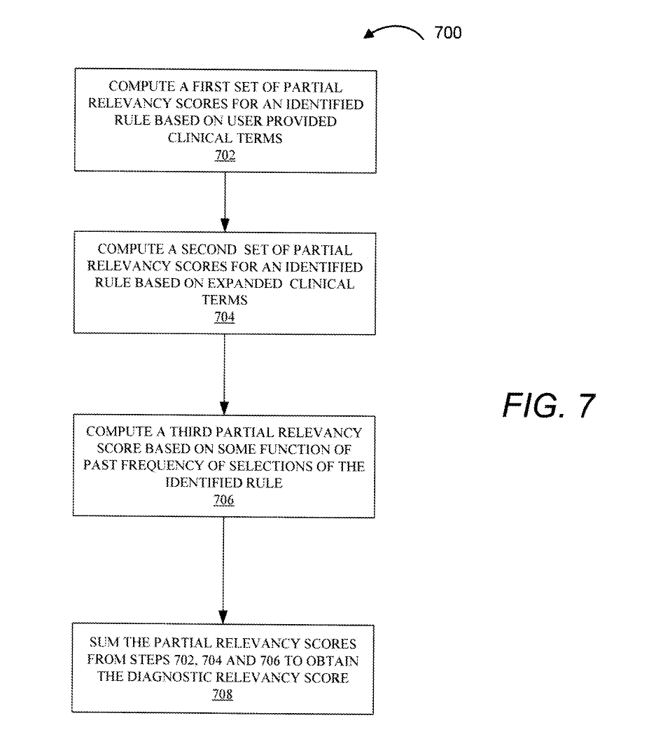

In one embodiment, a diagnostic relevancy score may be dynamically computed and assigned to the identified rules using the rule ranking algorithm in accordance with a rule's hierarchical order in a hierarchical decision tree, such as the one described below with reference to FIG. 6 and the flow diagram of FIG. 7.

### Decision Tree

In an embodiment, the single system compatible rule set is stored in data repository 30 may be organized as a hierarchical decision tree, such as the one shown in FIG. 6 to facilitate the identification and selection of relevant rules, as well as calculation of the diagnostic relevancy scores of the identified rules by the rules engine 24.

FIG. 6 illustrates an exemplary portion of a rule set 600 organized as a hierarchical decision tree. It should be appreciated that as a practical matter, a decision tree may include thousands of nodes organized in hierarchical fashion.

The hierarchical decision tree representing the rule set is shown to be comprised of leaf nodes and non-leaf nodes. The non-leaf nodes of the decision tree represent various patient conditions and the leaf nodes of the tree represent candidate procedures associated with one or more of the patient conditions.

Associated with each non-leaf node in the tree are a set of clinical terms, which are not shown. These clinical terms are populated into the non-leaf nodes of the tree by the rules Indexer component 230 at the pre-operational stage. The rules indexer component 230 maps various clinical terms associated with each patient condition to the appropriate nodes in the tree. The mapping file of table I, described above, describes one such mapping of a patient condition to clinical terms.

Associations of patient conditions (non-leaf nodes) and candidate procedures (leaf nodes) comprise the rules of the decision tree. In general, a rule may have one or more patient conditions and one or more associated candidate procedures.

Referring to FIG. 6, by way of example only, there is shown non-leaf node 601, labeled “Chronic Neck Pain”, which corresponds to a general patient condition. This non-leaf node 601 is a parent node to non-leaf child nodes 602 and 603. It should be understood that while non-leaf node 601 is a parent to child nodes 602, 603, it may also be a child node to higher order non-leaf nodes in the tree, which are not shown. The higher order nodes would typically describe the condition “chronic neck pain” at a higher, more abstract level than is represented by non-leaf node 601.

Non-leaf child nodes 602, 603 describe different aspects of the patient condition “chronic neck pain” with greater particularity than parent non-leaf node 601. For example, non-leaf node 602, labeled “Radiographs show Spondolysis, Neurologic signs or conditions present” and non-leaf node 603 labeled “Radiographs show Spondolysis, No Neurologic conditions” describe non-leaf node 601, “chronic neck pain” with greater particularity by specifying the type of neck pain.

Associated with non-leaf child nodes 602, 603 there is shown a number of associated child leaf nodes 604-612. The child leaf nodes represent candidate procedures that are associated with the patient conditions described by the non-leaf (parent) nodes 602, 603. For example, the seven child leaf nodes 604-610 describe seven separate and distinct candidate procedures that are associated with the parent non-leaf node 602.

A patient condition may, in certain cases, be a compound condition. For example, chronic neck pain and radiographs show spondolysis, neurologic signs or conditions present.

A rule associates the patient condition above with one or more candidate procedures, e.g., procedures 604-610.

As a further example, multiple patient conditions are also contemplated. For example, chronic neck pain and radiographs show spondolysis, with No neurologic signs or conditions present, may be associated with candidate procedures 611 and 612, describing a second rule of the tree.

As shown, candidate procedures are associated with only the leaf nodes of the tree. Each candidate procedure also includes an associated appropriateness score. For example, leaf node 604, “MRI Cervical Spine w/o contrast” has an associated appropriateness score of [9]. Appropriateness scores are values assigned to leaf nodes by subject matter experts such as radiologists, and are stored in data repository 30 as part of the CDS rule set. Appropriateness scores are displayed to the user when the user is shown a list of relevant rules to provide the user with a numerical indication of the efficacy of an identified candidate procedure. In one embodiment, appropriateness scores may range from 0-9 with 9 being the highest score indicating a highly effective procedure as determined by subject matter experts. Of course, other numerical measures and scales are within contemplation of the invention.

### Computing the Diagnostic Relevancy Score

In an embodiment, once the rules engine 24 has identified one or more relevant rules based on the user-provided primary clinical information and the expanded clinical information, a diagnostic relevancy score is computed for each identified rule as a summation of partial relevancy scores, where a first set of partial relevancy scores are based on the user provided primary clinical terms and the second set of partial relevancy scores are based on the derived clinical terms. Thereafter, a third partial score based on a previous rule selection algorithm is added to the first and second partial relevancy scores to generate the diagnostic relevancy score for the rule.

In one embodiment, the diagnostic relevancy score of a rule R in the identified rules is computed by the rule's engine 24 in the following manner.

The primary clinical information including one or more clinical terms that were provided by a clinician at the outset of a patient clinical session are now retrieved by the rules engine 24 to determine the diagnostic relevancy score of the rule R. Each primary clinical term is used as an index to the mapping file, discussed supra, to identify an associated patient condition that comprises a part of the rule R. From the mapping file, the weight value associated with the patient condition comprises a partial relevancy score for the rule R. This process is repeated for each primary clinical term to generate a first set of partial relevancy scores for the rule R. Thereafter, the process is repeated for each derived clinical term to generate a second set of partial relevancy scores for the rule R.

By way of example, if a clinician inputs three clinical terms and is shown 5 rules identified as being relevant to the three clinical terms and terms derived therefrom. It is required to compute a diagnostic relevancy score for each of the five rules. To compute a diagnostic relevancy score for the first rule, each of the three clinical terms are used as indices to the mapping file to determine if there is a patient condition associated with the clinical terms that forms a part of the first rule. If so, the weight value associated with the one or more identified patient conditions comprise a first set of partial relevancy scores. This process is repeated for any derived clinical terms to form a second set of partial relevancy scores.

Having determined the first and second sets of partial relevancy scores for a rule, the rule's overall diagnostic relevancy score may be computed by further adding a weight related to the frequency of past selections of the rule R given the same set of input clinical information including one or more clinical terms. The clinical terms of the current clinical session may be viewed as a group of terms that are collectively applied as a single index to a database of records which stores statistics regarding the frequency with which a particular rule was selected given a particular grouping of input clinical terms. For example, if three clinical terms are provided by a clinician in a current clinical session, those three terms are grouped and used as a single index into a statistical database to identify the frequency with which the rules identified in the current clinical session were selected in previous clinical sessions. The frequency with which a rule has been selected in the past based on the same set of clinical facts can be any value between 0-100%. In one embodiment, a rule will be assigned a weight value that is proportionate to the rule's past frequency of selection. In one embodiment, the assigned weight value can be an integer value corresponding to the past frequency of selection, e.g., weight value=20 points=20% past selection of a rule given the same set of clinical terms. In other embodiments, different weight values may be assigned based on the percentage value.

FIG. 7 is a more detailed flow diagram 700 of step 408 of the flow diagram of FIG. 4 in accordance with one embodiment. Recall from above that step 408 relates to a method of computing a diagnostic relevancy score for those rules identified by the rules engine component 24, as being relevant at step 406 of FIG. 4.

At step 702, compute, by a processing device, such as the rules engine 24, a first set of partial relevancy scores for an identified rule as a function of user-provided primary clinical terms determined to be relevant to a patient condition portion of the identified rule.

At step 704, compute, by the processing device, such as the rules engine 24, a second set of partial relevancy scores for the identified rule as a function of expanded clinical terms derived from user-provided primary clinical terms that are determined to be relevant to a patient condition portion of the identified rule.

At step 706, compute, by the processing device, such as the rules engine 24, a third partial relevancy score based on some function of a frequency of previous selections of the identified rule.

At step 708, sum, by the processing device, such as the rules engine 24, the partial relevancy scores indicated at steps 702, 704 and 706 to obtain the diagnostic relevancy score for the identified rule.

### Pre-Operational Stage

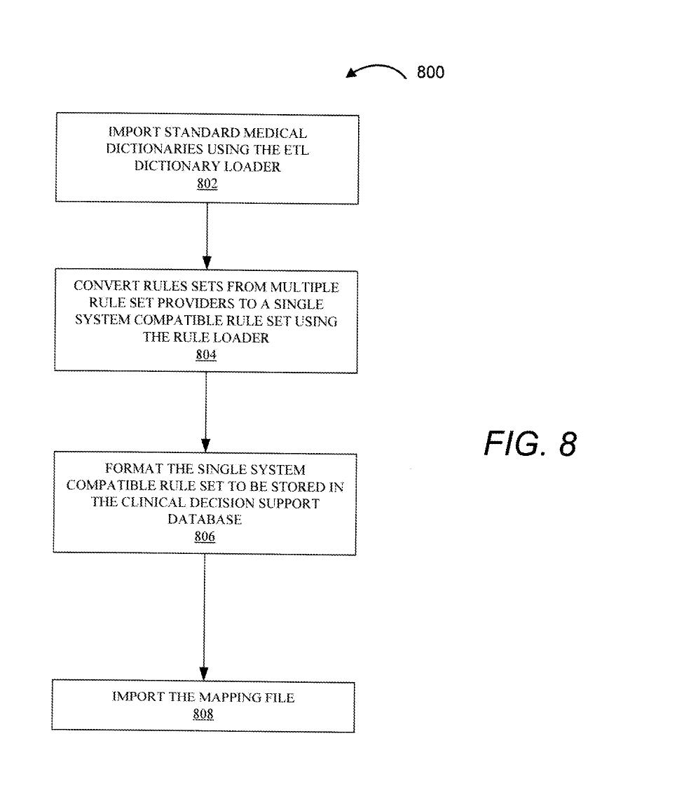

Prior to using the CDS system, during a pre-operational stage, it is necessary to acquire certain rule sets, a mapping file and SNOMED, IC9 and CPT definitions from a number of external data sources. This process is described with reference to FIG. 8 at a high level as follows.

FIG. 8 is a flow diagram 800 of steps performed during a pre-operational stage according to one embodiment.

At step 802, the ETL component 22 of the CDS system imports standard medical dictionaries such as ICD9 code set and CPT code set using the ETL Dictionary Loader component 19.

At step 804, the ETL component 22 of the CDS system converts imported rule sets 201-1, 201-2, 201-3 into a single system compatible rule set. The CDS system may import more or less rule sets dependent upon the particular application.

At step 806, the single system CDS compatible rule set is stored in the data repository 30. It should be understood that the single system compatible rule set can be divided into sub-sets of rules so that different users can subscribe to different subsets of rules depending upon the user's particular application needs. When a customer signs on with the CDS system, the customer is offered the choice of subscribing to one or more of the different subsets of rules. For example, a hospital may only wish to use a radiology rule subset while another hospital may only wish to use a cardiology rule subset.

One particular rule subset is the user warnings rule subset which uniquely ascribes warnings to the antecedent portion of the rules. That is, a rule takes on the general form of a condition and one or more associated recommended procedures. However, in the case of the user warnings rule subset, the recommended procedures are replaced by warnings.

At step 808, the Rule Indexer component 230 is enabled to import a mapping file 13, which is generally comprised of industry expert created associations between patient conditions and clinical terms.

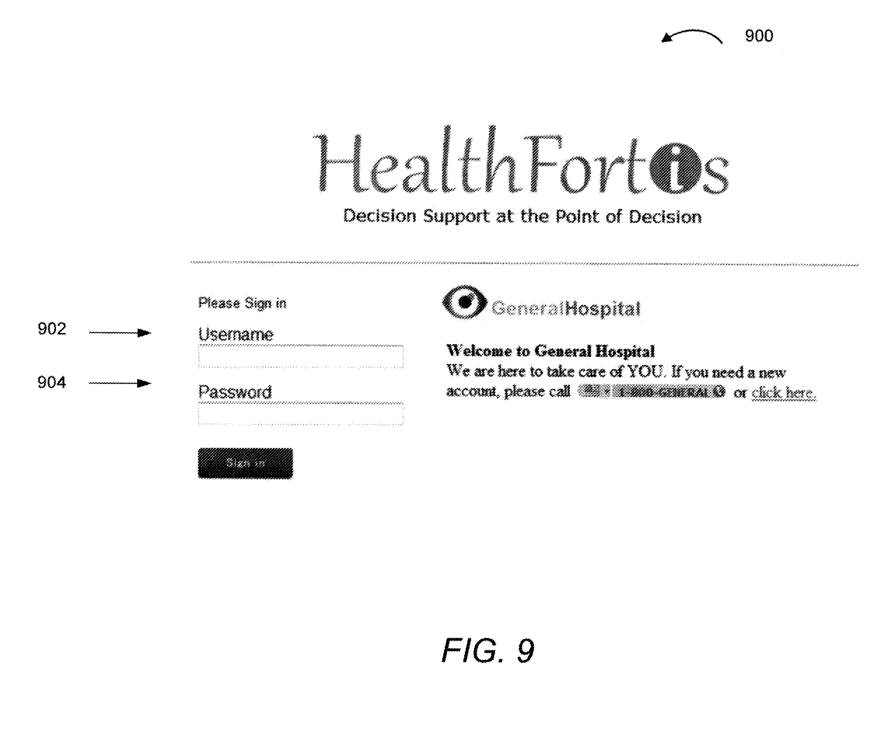

The illustrative CDS system 20 shown in FIG. 1 is further described with reference to selected illustrative display screenshots shown in FIGS. 9-15.

FIG. 9 illustrate an exemplary “Login” screen 900. In an embodiment, a username 902 and password 904 are provided to gain access via “Sign-in” icon.

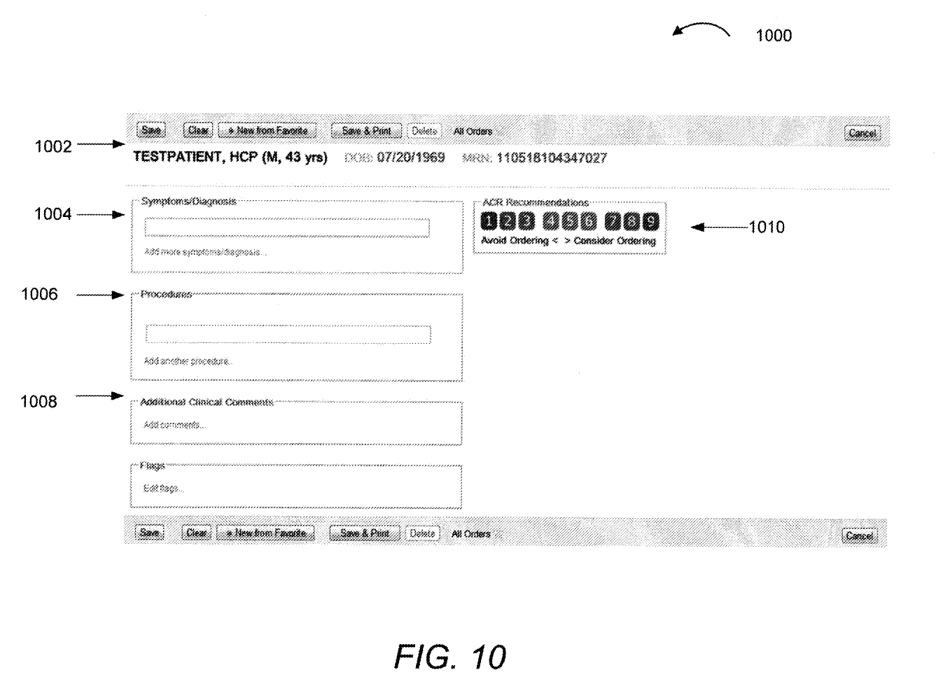

FIG. 10 illustrates an “Entry” screen 1000 that is shown to a user at the start of a clinical decision support event for supporting an exemplary patient, “TESTPATIENT”. In an embodiment, the “Entry” screen 1000 includes a patient information area 1002, a condition/diagnosis area 1004, a procedure area 1006, a comments area 1008, and a recommendation score index 1010. General patient information is provided in the patient information area 1002 to indicate the current patient being evaluated. The condition/diagnosis area 904 is provided to allow a user to enter user provided clinical information including primary clinical terms. The procedure area 1006 is provided to enter candidate procedures by a user or to display procedures selected by the user from the recommendations provided by the CDS system. The comments area 1008 is provided to enter user comments. The recommendation score index 1010 is provided to indicate the efficacy of a candidate procedure as determined by the CDS rules processing component.

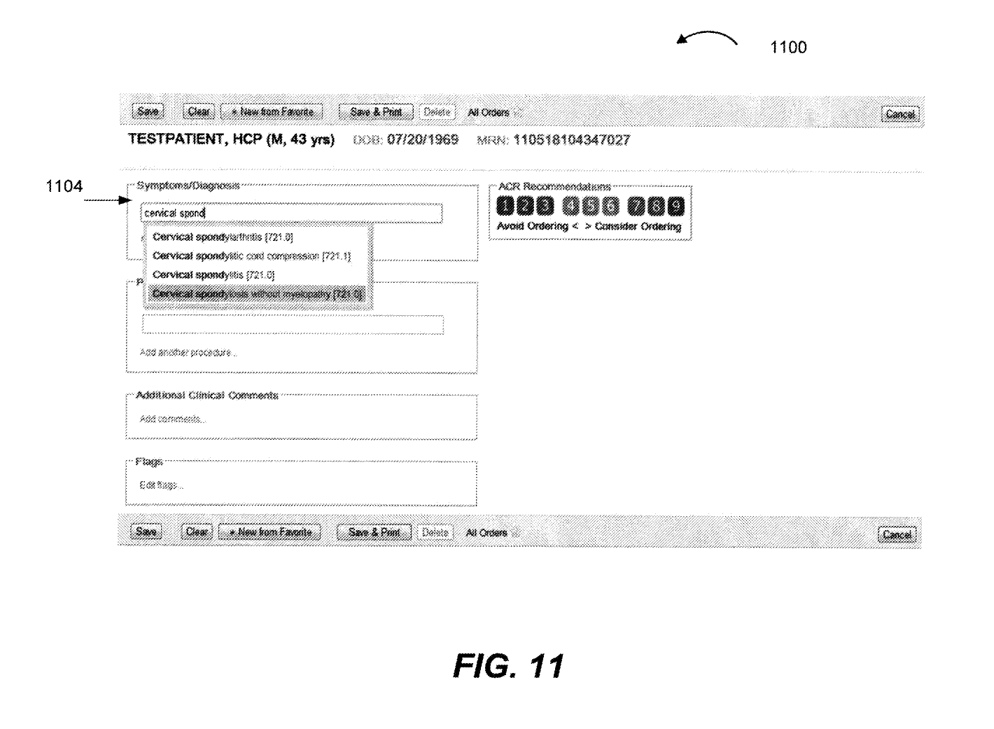

FIG. 11 illustrates how a physician begins to interact with the “Entry” screen 1100 at the start of a clinical decision support event. The physician begins a support event by entering clinical information including one or more clinical facts in the condition/diagnosis area 1104. Upon entering the clinical information, a drop down box is displayed to the user which attempts to anticipate the full clinical term as it is being typed in. For example, as the user begins to enter the clinical term “cervical spond . . . ”, a drop down box appears which attempts to anticipate the full condition name “cervical spondolysis. In addition to providing initial patient clinical information, subsequent to receiving applicable rules identified by the system, a physician/provider may enter additional clinical information or and/or negate facts previously presented by the physician.

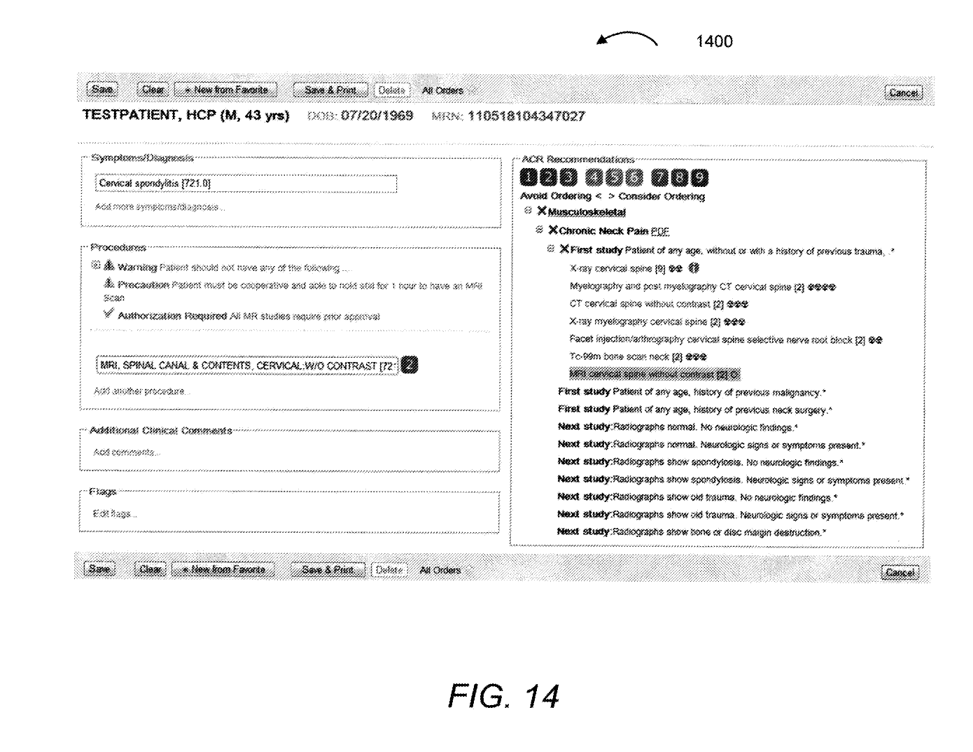

A physician may optionally suggest candidate procedures to the CDS rules engine 24 by entering the user suggested candidate procedure at the “Entry” screen, conditions/Diagnosis area 1004 as shown in FIG. 10. Once entered, the user suggested candidate procedure will be evaluated by assigning it an appropriateness score, as will be further described with reference to FIG. 14 below.

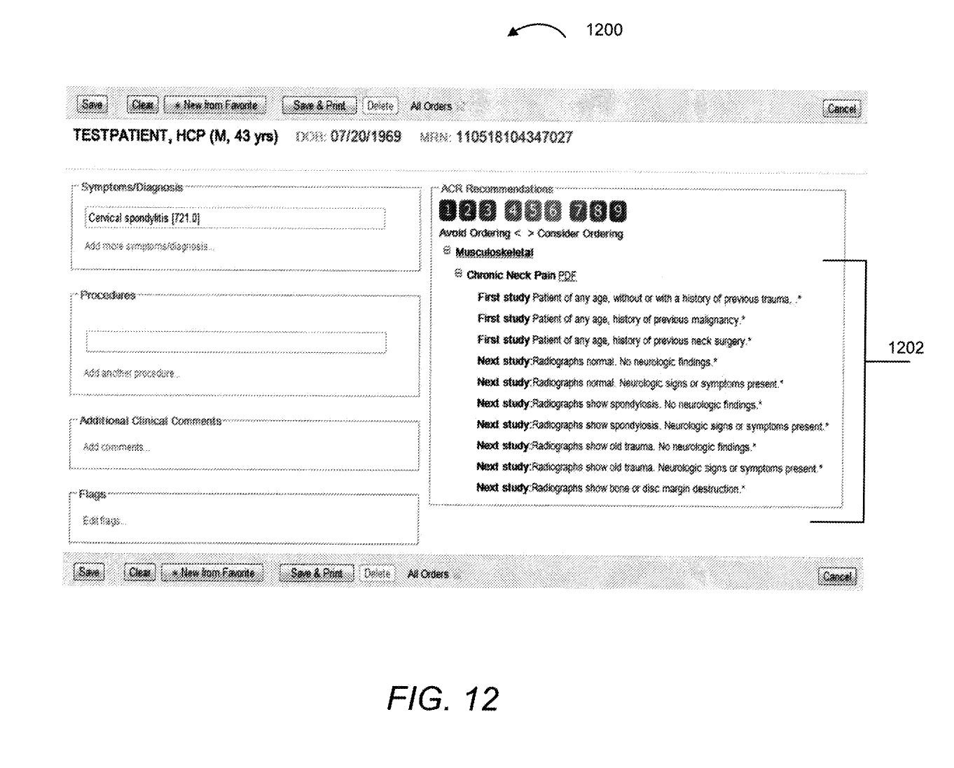

FIG. 12 illustrates what is shown to the user after the user enters all of the primary clinical information and requests a search result of relevant rules from the CDS system. In the present example, based on the user provided inputs, the rules engine component 24 of the CDS system identifies and returns ten rules 1202 as being relevant to the user provided clinical term: “cervical spondolysis” The ten rules are displayed in rank order from highest to lowest rank in accordance with the rule ranking algorithm, discussed above.

The rules in general comprise patient conditions and associated candidate procedures, where the patient conditions are hierarchically structured from the most general to the most specific patient condition. It should be appreciated that the candidate procedure portion of the rules are not shown in the screen shot of FIG. 12, however, they are available to be viewed upon the user selecting one of the ten displayed specific patient condition portions of the rules 1202.

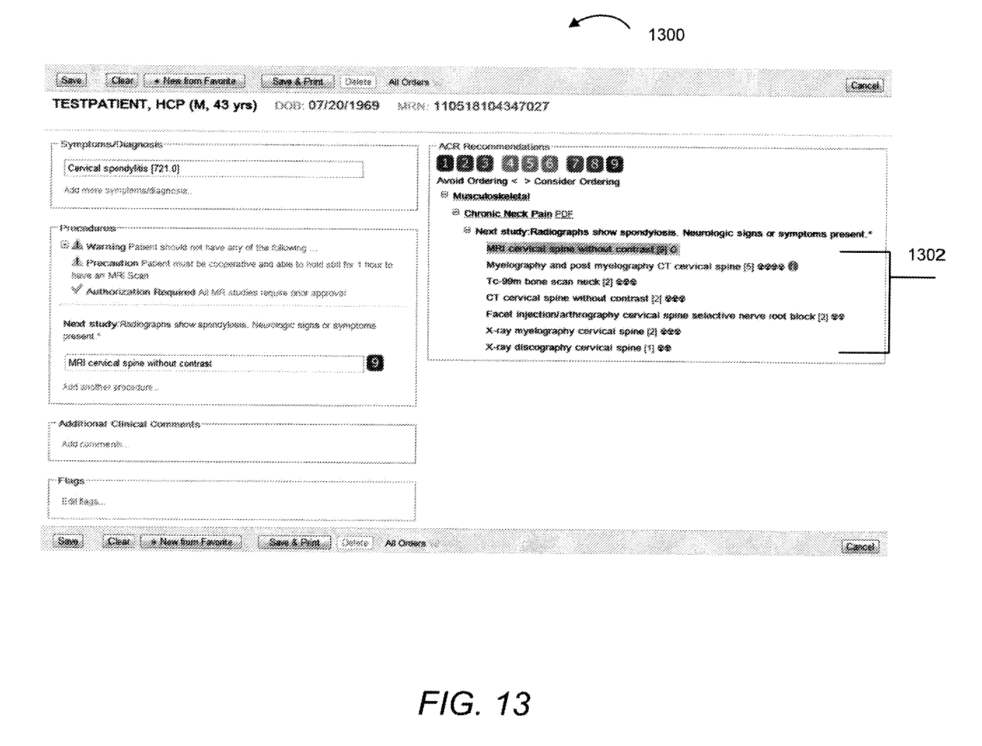

The following table provides additional understanding regarding the patient condition portion of the rules that are displayed in the screen shot of FIG. 12. The screen shot of FIG. 12 only shows the multi-tiered patient condition portion of the identified rules, as reproduced in the table below. However, the associated candidate procedure portion of the rules may be shown to the user upon selecting one of the rules, as illustrated in FIG. 13.

TABLE II

| RULE # | Multi-tiered Patient condition | | |
|---|---|---|---|
| 1 | Musculoskeletal | Chronic Neck Pain | Patient of any age, without or with a |
| | | | history of previous trauma |
| 2 | Musculoskeletal | Chronic Neck Pain | Patient of any age, history of previous |
| | | | malignancy |
| 3 | Musculoskeletal | Chronic Neck Pain | Patient of any age, history of previous |
| | | | neck surgery |
| 4 | Musculoskeletal | Chronic Neck Pain | Radiographs normal, neurological signs or |
| | | | symptoms present |
| 5 | Musculoskeletal | Chronic Neck Pain | Radiographs normal, show old trauma, |
| | | | No neurologic findings |
| 6 | Musculoskeletal | Chronic Neck Pain | Radiographs show spondolysis, no |
| | | | neurology findings. |
| 7 | Musculoskeletal | Chronic Neck Pain | Radiographs show spondolysis, |
| | | | neurological signs or symptoms present |
| 8 | Musculoskeletal | Chronic Neck Pain | Radiographs show old trauma, no |
| | | | neurologic findings |
| 9 | Musculoskeletal | Chronic Neck Pain | Radiographs show old trauma, neurologic |
| | | | signs or symptoms present |
| 10 | Musculoskeletal | Chronic Neck Pain | Radiographs show bone or disc margin |
| | | | destruction |

FIG. 13 illustrates what is shown upon the user selecting one of the ten rules. In the example, the user has selected rule #6 from the screen shot of FIG. 12, i.e., “Radiographs show spondolysis, Neurological signs or symptoms present” and is shown 7 candidate procedures 1302 associated with the selected rule.

Referring now to FIG. 14, in addition to the user entering patient clinical information including one or more clinical facts, the user may optionally enter a procedure in the procedure area. FIG. 14 illustrates by example, the entry of a user provided procedure, i.e., “MRI Cervical Spine without Contrast” in the procedure area 1006 of FIG. 10. Upon submitting the procedure, the user is shown the candidate procedures of a rule having the lowest appropriateness score for the user submitted procedure.

Whenever a user enters a procedure in addition to entering primary clinical information, an appropriateness score is computed for the user provided procedure and displayed on the “Entry” screen. The appropriateness score assigned to the user provided procedure is determined by comparing the user provided procedure with the candidate procedures of the displayed rules that have been previously identified by the rules engine component 24. If the user provided procedure matches one of the candidate procedures associated with one or more of the displayed rules, the user provided procedure will be assigned the lowest appropriateness score from among the matching candidate procedures.

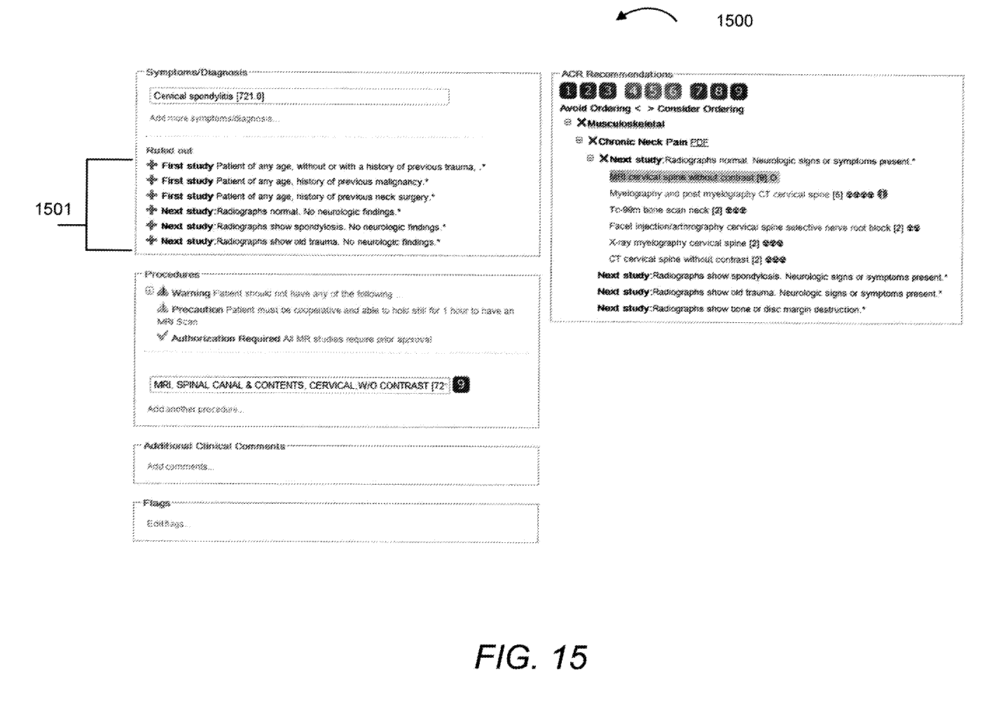

Referring now to FIG. 15, the user has the ability to “rule out” certain recommended patient conditions. A user can rule out a patient condition portion of a rule by “clicking” on the X mark to the immediate left of the condition, which causes the condition to re-appear on the left hand side of the screen 1501. In the present example, the user has “ruled out” six patient conditions. This process of ruling out conditions can be considered as providing additional information to the CDS system to the rules engine component 24 to refine the prognosis.

It is understood that embodiments of the present invention may be operational with numerous general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

Embodiments of the present invention may be described in the general context of computer-executable instructions, such as program components, being executed by a computer. Generally, program components include, but are not limited to, routines, programs, objects, components, and data structures that perform particular tasks or implement particular abstract data types. Embodiments of the present invention may also be practiced in distributed computing environments where tasks are performed by remote processing devices that are linked through a communications network. In a distributed computing environment, program components may be located in local and/or remote computer storage media including, by way of example only, memory storage devices.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

At least portions of the functionalities or processes described herein can be implemented in suitable computer-executable instructions. The computer-executable instructions may be stored as software code components or components, the components may be on one or more computer readable media (such as non-volatile memories, volatile memories, DASD arrays, magnetic tapes, floppy diskettes, hard drives, optical storage devices, etc. or any other appropriate computer-readable medium or storage device). In one embodiment, the computer-executable instructions may include lines of complied C++, Java, HTML, or any other programming or scripting code.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such non-limiting examples and illustrations includes, but is not limited to: “for example,” “for instance,” “e.g.,” “in one embodiment.”

The described embodiments of the invention are merely an example; many other embodiments are possible within the scope of the invention. Further modifications of the disclosed embodiments may be understood from a study of the drawings, the disclosure, and the appended claims and carried into practice by those skilled in the art. In the claims, the word “comprising” or “comprise” does not exclude other elements or steps, and the indefinite article “a” or “an” does not exclude a plurality. Any reference signs in the claims should not be construed as limiting the scope.

What is claimed is:

1. An interactive computer assisted method in a clinical computing environment for providing clinical decision support, the method comprising the steps of:
a) receiving from a user, at a processing device, primary clinical information associated with a patient, wherein the primary clinical information includes one or more primary clinical terms;
b) deriving, by the processing device, expanded clinical information from the user-provided primary clinical information, wherein said expanded clinical information includes one or more expanded clinical terms;
c) identifying, by the processing device, one or more relevant rules based on the user-provided primary clinical information and the expanded clinical information,
d) computing, by the processing device, the diagnostic relevancy score for each identified rule, and
e) displaying each identified relevant rule to the user in ranked order based on the rule's computed diagnostic relevancy score.

2. The method of claim 1, wherein a rule comprises one or more patient conditions and one or more candidate procedures associated with the one or more patient conditions.

3. The method of claim 1, wherein said expanded clinical information is derived either by inference or by querying one or more internal and/or external data sources.

4. The method of claim 2, wherein for each rule, the diagnostic relevancy score is computed as a sum of partial relevancy scores computed as a function of the user-provided primary clinical information and the derived expanded clinical information.

5. The method of claim 4, wherein computing the partial relevancy scores further comprises:
computing, by the processing device, a first set of partial relevancy scores for the identified rules as a function of said user-provided primary clinical terms that are determined to be relevant to at least one identified patient condition of an identified rule, and
computing, by the processing device, a second set of partial relevancy scores as a function of said expanded clinical term that are determined to be relevant to said at least one identified patient condition of the identified rule,
computing, by the processing device, a further partial relevancy score as a function of the frequency of previous selections of the identified rule under the same set of clinical terms and expanded terms as the received one or more primary clinical terms and the one or more expanded clinical terms, and
summing the first set of partial relevancy scores and the second set of partial relevancy scores and the further partial relevancy score to obtain the diagnostic relevancy score.

6. The method of claim 5, wherein the computation of the first set of partial relevancy scores for an identified rule further comprises:
(a) retrieving a first primary clinical term from among the one or more primary clinical terms previously received as one input to the rules engine,
(b) accessing a mapping file comprising mapping data, wherein said mapping data comprises data associating patient conditions to clinical terms, wherein the patient condition and clinical term association has an associated weight value,
(c) using the primary clinical term as an index to the mapping file to identify a patient condition in the mapping file that is a part of the identified rule,
(d) assigning the weight value associated with the identified patient condition and the first primary clinical term as a first partial relevancy score of the identified rule, and
(e) repeating steps (a)-(d) for the other clinical terms from among the one or more primary clinical terms provided as further inputs to the rules engine.

7. The method of claim 5, wherein the computation of the second set of partial relevancy scores for an identified rule further comprises:
(a) retrieving an expanded clinical term from among the one or more expanded clinical terms previously received as one input to the rules engine,
(b) accessing a mapping file comprising mapping data, wherein said mapping data comprises data associating patient conditions to clinical terms, wherein the patient condition and clinical term association has an associated weight value,
(c) using the expanded clinical term as an index to the mapping file to identify a patient condition in the mapping file that is a part of the identified rule,
(d) assigning the weight value associated with the identified patient condition and the expanded clinical term as a second partial relevancy score of the identified rule, and
(e) repeating steps (a)-(d) for the other clinical term from among the one or more primary clinical terms provided as further inputs to the rules engine.

8. The method of claim 2, wherein a rule may be identified as relevant even if not all of the patient conditions are determined to be relevant to a user provided clinical term or an derived expanded clinical term.

9. The method of claim 1, wherein said step of identifying one or more rules as being relevant at said step (c), further comprises the steps of:
accessing a mapping file comprising mapping data, wherein said mapping data comprises data associating patient conditions to clinical terms,
determining, by a processing device, if one or more of said clinical terms in said mapping file matches one or more of said user-provided primary clinical terms or expanded clinical terms,
selecting the patient conditions from the mapping file associated with matching clinical terms included in the mapping file at said determining step,
accessing a rule set comprising a set of rules, wherein each of said rules in said rule set comprises rules associating one or more patient conditions to one or more candidate procedures,
identifying one or more rules from said rule set that include at least one of the selected patient conditions and
excluding any rules having a patient condition portion that is contradictory with one of the selected patient conditions.

10. The method of claim 1, further comprising the step of: the user ruling out one or more recommended patient conditions associated with a displayed rule and repeating steps (c) through (e) of claim 1.

11. The method of claim 1, further comprising the act of displaying to the user an appropriateness score for each candidate procedure of an identified relevant rule.

12. The method of claim 10, further comprising:
a user entering a procedure,
comparing, by the processing device, the user-entered procedure with the candidate procedures associated with the previously identified rules to determine if there is a match; and
assigning, by the processing device, the lowest appropriateness score from among the matching candidate procedures from among the previously identified rules.

13. A system comprising:
a memory device having a plurality of routines stored therein;
a processor configured to execute the plurality of routines stored in the memory device, the plurality of routines comprising:
a routine configured to, when executed, receive primary clinical information from a user associated with a patient;
a routine configured to, when executed, derive expanded clinical information from the user-provided primary clinical information;
a routine configured to, when executed, identify relevant rules from a data store based on the user-provided clinical information and the expanded clinical information;
a routine configured to, when executed, compute a diagnostic relevancy score for each of the identified relevant rules;
a routine configured to, when executed, assign, by the processing device, the computed diagnostic relevancy score to each identified relevant rule; and
a routine configured to, when executed, display each identified rule in ranked order based on the rule's assigned diagnostic relevancy score.

14. The system of claim 13, further comprising, a mapping file configured as a plurality of records mapping patient conditions to clinical terms associated with the patient conditions.

15. The system of claim 13, further comprising, a user interface (UI) component that displays each identified patient condition/procedure candidates based rule in ranked order based on the rule's assigned diagnostic relevancy score.

16. The system of claim 13, further comprising, a web service interface configured to receive the user-provided clinical information from an external system.

17. The system of claim 13, further comprising, a rules Loader component configured to receive one or more rule sets provided from one or more rule providers.

18. The system of claim 13, further comprising, an ETL dictionary loader component configured to receive dictionary data such as SNOMED, IC9 and CPT codes from one or more sources.

19. The system of claim 13, further comprising, a rules indexer component configured to receive a mapping file, configured as a plurality of records, where each record maps one or more patient conditions to one or more clinical terms associated with the one or more patient conditions.

20. A storage medium storing instructions executable by a digital processor (20) to perform the CDS method set forth in claim 1.
